(19) United States
(12) Patent Application Publication
(10) Pub. No.: US 2004/0066857 A1
(43) Pub. Date: Apr. 8, 2004

(54) Reducing I/Q imbalance through image rejection

(76) Inventors: Radha Srinivasan, Culver City, CA (US); Meng-Chang Doong, Alhambra, CA (US); Qiang Lin, Pasadena, CA (US)

Correspondence Address: Jonathan W. Hallman, MacPHERSON KWOK CHEN & HEID LLP, Suite 210, 2402 Michelson Drive, Irvine, CA, 92612, US

(21) Appl. No.: 10/263,992

(22) Filed: Oct. 2, 2002

(51) Int. Cl. H04L 27/36; H04L 27/20; H04L 27/22

(52) U.S. Cl. 375/298; 332/103; 375/322; 329/304

(57) ABSTRACT

Algorithms are provided to adjust the gain and phase imbalance of I/Q modulators and demodulators. The imbalances are adjusted through an adjustment range and the corresponding image signal powers determined. The minimum image signal power identifies the calibration settings for the gain and phase imbalances.

### FIELD OF INVENTION

This invention relates to reducing I/Q imbalance using image rejection and more specifically to calibrating I/Q modulators and I/Q demodulators to reduce the image.

### BACKGROUND

I/Q modulators and demodulators are common components for communication and signal processing systems in both digital and analog form. An analog version of an ideal I/Q modulator 10 is illustrated in FIG. 1. I/Q modulator 10 receives the I and Q components of a digital modulating signal after they have been processed by digital-to-analog converters (DAC) and low-pass filters (LPF). The processed analog I and Q components are received by double sideband mixers 20 and 25, respectively. Mixer 20 modulates the in-phase component cos ω_{c}t of a carrier with the I component. A quadrature phase-shifter (not illustrated) shifts the in-phase carrier component into a quadrature-phase component sin ω_{c}t, which is then modulated by mixer 25 according to the Q component of the modulating signal. An adder 30 combines the outputs of each mixer 20 and 25 to produce the modulated analog signal S(t). Because they are double sideband mixers, both mixers 20 and 25 will produce a modulated signal having both an upper sideband (USB) and a lower sideband (LSB) component. For example, if the I component is given by cos ωₘt, the output of mixer 20 will be:

cos ω_{c}t*cos ωₘt=½cos(ω_{c}+ωₘ)t[the USB component]+½cos(ω_{c}−ωₘ)t[the LSB component]

However, the signal addition performed by adder 30 can cancel one of these sidebands, thereby enhancing spectral efficiency. For example, if the Q component of the modulating signal is given by −sin(ωₘt), S(t) becomes:

S(t)=cos ω_{c}t·cos ωₘt−sin ω_{c}t·sin ωₘt=cos(ω_{c}+ωₘ)t[the USB component]

Similarly, if the Q component is given by sin ωₘt, only the LSB component is expressed. As a result of this spectral efficiency, I/Q modulators and de-modulators are very popular for digital modulation schemes such as QPSK and QAM.

But such a complete cancellation of one of the sidebands is only achieved under ideal circumstances. For example, I/Q modulator 10 of FIG. 1 requires equal amplitude for the carrier inputs to mixers 20 and 25. Moreover, the phase-shift provided by the quadrature phase-shifter must be precisely 90 degrees. In addition, the electrical length between in-phase combiner 30 and mixers 20 and 25 must be the same. Finally, the low pass filters and digital-to-analog converters in the in-phase and quadrature arms must be matched. Such ideal characteristics are not achievable in realistic I/Q networks. Instead, a conventional I/Q modulator may be modeled by I/Q modulator 50 as shown in FIG. 2. In I/Q modulator 50, all components are as described with respect to I/Q modulator of FIG. 1 except that the carrier components are not equal in amplitude and are not in quadrature with each other. Thus, mixer 20 receives (1+α)cos ω_{L}t, and mixer 25 receives (1−α)sin(ω_{L}t+θ), where ω_{L} is used to represent the carrier frequency, α represents the gain imbalance, and θ represents the phase imbalance. As a result, the output S(t) of in-phase combiner 30 becomes:

$$S ( t ) = \{ \frac{( 1 + α )}{2} cos [ ( {ω}_{L} + {ω}_{M} ) t ] + \frac{( 1 - α )}{2} cos [ ( {ω}_{L} + {ω}_{M} ) t + θ ] \} + \{ \frac{( 1 + α )}{2} cos [ ( {ω}_{L} - {ω}_{M} ) t ] - \frac{( 1 - α )}{2} cos [ ( {ω}_{L} - {ω}_{M} ) t + θ ] \}$$

The first bracketed quantity is the USB component and the second bracketed component is an undesired LSB image that results when the gain offset a and phase offset θ are non-zero. For example, the I and Q components received by I/Q modulator 50 may form a baseband signal whose spectrum is illustrated in FIG. 3a. If both the gain imbalance a and the phase imbalance θ do not exist, I/Q modulator 50 thus produces a USB output signal S(t) whose spectrum is shown in FIG. 3b. If, however, the gain imbalance and phase imbalance between the in-phase arm and the quadrature-phase arm are non-zero, an LSB image will also be present in the output spectrum as illustrated in FIG. 3c. The power of this image will increase as the gain and phase offsets are increased. Because such images destroy the spectral efficiency of I/Q networks and may increase bit error rates, particularly at the higher throughput digital modulation schemes, image rejection techniques have been developed. For example, G. Yang, et al., I/Q Modulator Image Rejection Through Modulation Pre-distortion,” IEEE 46^{th} Vehicular Technology Conference, Vol. 2, 1996 disclose a image rejection technique involving “pre-distorting” the I and Q components of the modulating signal. However, such a technique requires access to the modulating signal, which may be impossible in systems wherein the modulating signal is produced by dedicated hardware such as an ASIC. Accordingly, there is a need in the art for improved image rejection techniques that do not require access to the modulating signal.

### SUMMARY

In accordance with an embodiment of the invention, a method of calibrating gain imbalance between the in-phase arm and the quadrature-phase arm of an I/Q modulator includes an act of providing a gain adjustment range. As the I/Q modulator modulates a signal, the gain imbalance of the I/Q modulator is adjusted through a plurality of sample points within the gain adjustment range so that a measurement can be made of the image signal power corresponding to each of the gain imbalance adjustment samples. The gain imbalance adjustment sample that results in the minimum image signal power determines the gain imbalance calibration setting for the I/Q modulator.

In accordance with another embodiment of the invention, a method of calibrating phase imbalance between the in-phase arm and the quadrature-phase arm of an I/Q modulator includes an act of providing a phase adjustment range. As the I/Q modulator modulates a signal, the phase imbalance of the I/Q modulator is adjusted through a plurality of sample points within the phase adjustment range so that a measurement can be made of the image signal power corresponding to each of the phase imbalance samples. The phase imbalance adjustment sample that results in the minimum image signal power determines the phase imbalance calibration setting for the I/Q modulator.

In accordance with another embodiment of the invention, a method of calibrating gain imbalance between the in-phase arm and the quadrature-phase arm of an I/Q demodulator includes an act of providing a gain adjustment range. As the I/Q demodulator demodulates a signal, the gain imbalance of the I/Q demodulator is adjusted through a plurality of sample points within the gain adjustment range so that a measurement can be made of the image signal power corresponding to each of the gain imbalance samples. The gain imbalance adjustment sample that results in the minimum image signal power determines the gain imbalance calibration setting for the I/Q demodulator.

In accordance with yet another embodiment of the invention, a method of calibrating phase imbalance between the in-phase arm and the quadrature-phase arm of an I/Q demodulator includes an act of providing a phase adjustment range. As the I/Q demodulator demodulates a signal, the phase imbalance of the I/Q demodulator is adjusted through a plurality of sample points within the phase adjustment range so that a measurement can be made of the image signal power corresponding to each of the phase imbalance samples. The phase imbalance adjustment sample that results in the minimum image signal power determines the phase imbalance calibration setting for the I/Q demodulator.

The invention will be more fully understood upon consideration of the following detailed description, taken together with the accompanying drawings.

### BRIEF DESCRIPTION OF THE DRAWINGS

FIG. 1 is a block diagram of an ideal I/Q modulator.

FIG. 2 is a block diagram of a conventional I/Q modulator.

FIG. 3a illustrates the spectrum of a baseband input signal for the I/Q modulator of FIG. 1.

FIG. 3b illustrates the output spectrum for the I/Q modulator of FIG. 2 in response to the baseband input signal of FIG. 3a when no gain or phase offset exists.

FIG. 3c illustrates the output spectrum for the I/Q modulator of FIG. 2 in response to the baseband input signal of FIG. 3a when either (or both of) a gain or a phase offset is present.

FIG. 4 is a block diagram of an I/Q modulator configured to perform gain calibration and phase calibration according to one embodiment of the invention.

FIG. 5 is a flowchart of a gain calibration algorithm for an I/Q modulator according to one embodiment of the invention.

FIG. 6 is a flowchart of a phase calibration algorithm for an I/Q modulator according to one embodiment of the invention.

FIG. 7 is a block diagram of an I/Q demodulator configured to perform a gain calibration and phase calibration according to one embodiment of the invention.

FIG. 8 is a flowchart of a gain calibration algorithm for an I/Q demodulator according to one embodiment of the invention.

FIG. 9 is a flowchart of a phase calibration algorithm for an I/Q demodulator according to one embodiment of the invention.

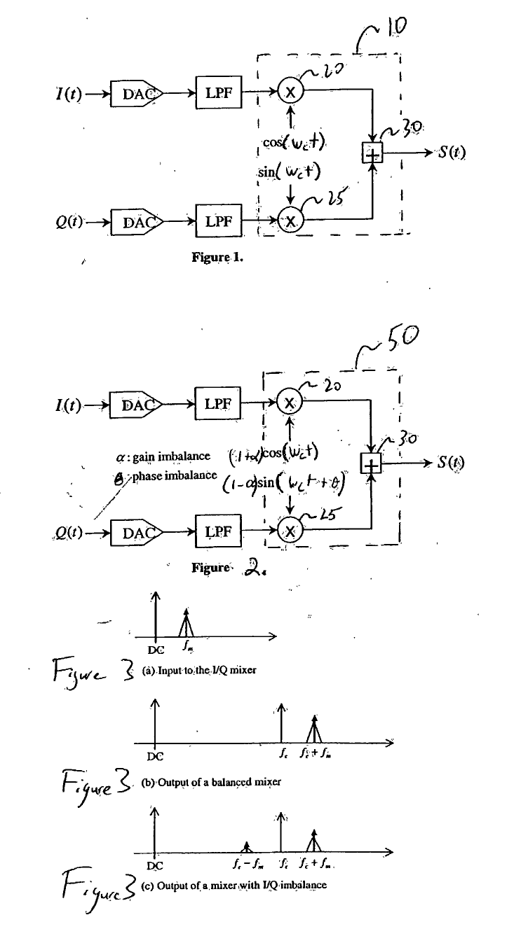

### DETAILED DESCRIPTION

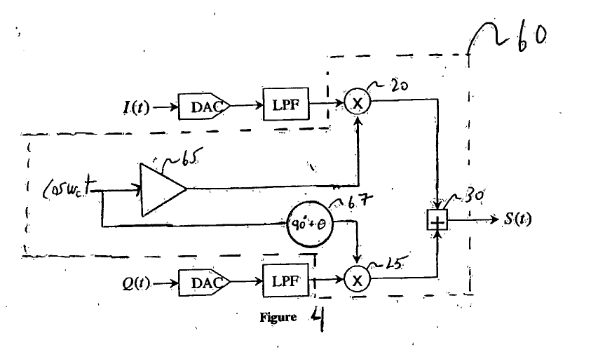

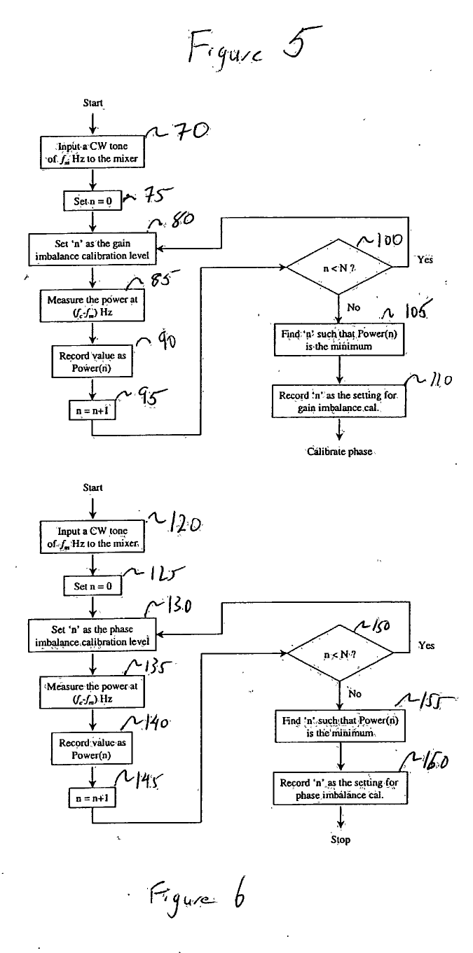

The present invention reduces the imbalance between the in-phase and quadrature-phase arms of an I/Q modulator or I/Q demodulator. Because this imbalance may be present in both phase and gain, a calibration technique is presented for both gain and phase. For example, FIG. 4 illustrates an I/Q modulator 60 configured to perform a gain calibration using a variable amplifier 65 and a phase calibration using variable phase-shifter 67. Variable amplifier 65 adjusts the gain of the in-phase component of the carrier. However, equivalent results may be obtained by adjusting the gain of the quadrature-phase component of the carrier. Alternatively, the amplitudes of both the in-phase and quadrature-phase components of the carrier may be varied with respect to one another. In addition, although amplifier 65 is shown adjusting a carrier signal component, this amplifier may be located in the modulating signal path. For example, amplifier 65 could adjust the LPF output or the DAC output in one or both of I and Q arms. Similarly, although phase-shifter 67 is shown adjusting the phase of the carrier's Q component, equivalent results may be obtained by adjusting the phase of the in-phase component of the carrier. Alternatively, the phases of both the I and Q components may be varied with respect to one another. As yet another alternative, the phase of the modulating signal components may be varied with respect to one another by the appropriate relocation of phase-shifter 67. Except for the addition of variable amplifier 65 and phase shifter 67, I/Q modulator 60 is as described with respect to I/Q modulator 50 of FIG. 2. However, for illustration clarity, the gain imbalance and phase imbalance between the in-phase carrier component and the quadrature-phase carrier component are not illustrated. The modulating signal may be a tone at a frequency fₘ within the expected operating band. Thus, the in-phase component I(t) may be represented by γcos(2nfₘt+Φ), and the quadrature-phase component may be represented by γsin(2nfₘt+Φ), where Φ is an arbitrary phase quantity and γ is an arbitrary gain quantity.

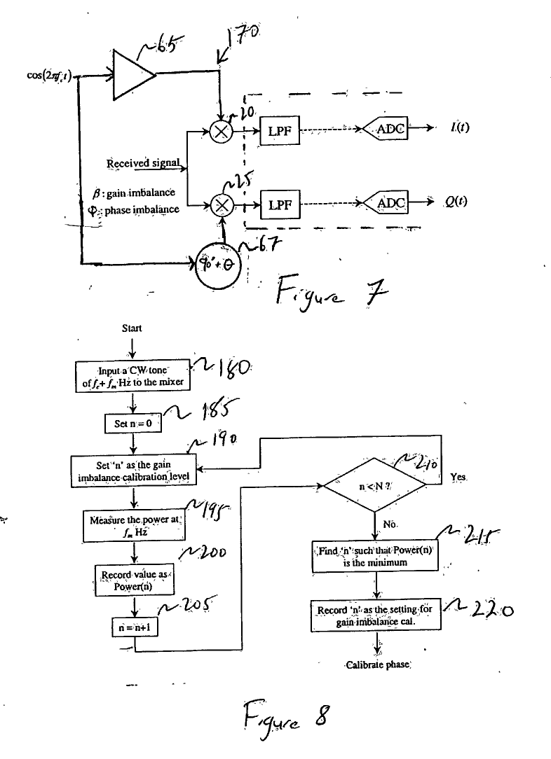

To calibrate the gain between the I and Q arms of the I/Q modulator 60, the gain of variable amplifier 65 is varied through an adjustment range, e.g., from −0.8 dB to +0.7 dB, where −0.8 dB is the minimum value of the adjustment range and +0.7 dB is the maximum value of the adjustment range. Assuming I/Q modulator 60 has been designed well, the gain imbalance should be slight so that such an adjustment range extending through 0 dB should locate the optimal gain setting. As the gain is varied through this adjustment range, the power of the resulting image signal is measured so that the gain may be calibrated accordingly. While varying the gain in equal increments through the adjustment range is particularly convenient, the gain increments could be varied such that smaller increments would be used in the vicinity of a suspected optimal gain setting so as to more finely sample this region. Turning now to FIG. 5, a flowchart for a transmitter gain imbalance calibration algorithm to locate the optimal gain setting using a constant gain increment is illustrated. In step 70, the algorithm begins by inputting a continuous wave (CW) tone at a frequency of fₘ Hz, where the frequency fₘ is chosen to be within the expected operating band. The in-phase and quadrature-phase components of this tone form the modulating signals I(t) and Q(t), respectively. At step 75, a calibration index variable n is set to zero. Variable amplifier 65 is configured to adjust its gain according to this calibration index. As n is incremented from 0 to a maximum value N, variable amplifier 65 will sweep through the adjustment range. For example, when n=0, variable amplifier 65 may be at the minimum value of its adjustment range, e.g., −0.8 dB. As n is incremented, the gain increases by a suitable increment such as 0.1 dB. Accordingly, at step 80, variable amplifier 65 will set its gain according to the value of the calibration index. At step 85, the power of the resulting image signal is measured. The frequency of the image signal depends upon whether the I/Q modulator is in an upper sideband (USB) or lower sideband (LSB) configuration. Because I/Q modulator 60 is an USB configuration, the image signal will have a frequency equaling the difference between the carrier signal frequency and the tone frequency, (f_{c}−fₘ). At step 90, the resulting image signal power for the current calibration index is recorded. At step 95, n is incremented a unit value. In this embodiment, because every increment of n increases the gain of variable amplifier 65, the gain of variable amplifier 65 will eventually exceed the maximum positive value of the adjustment range as n is increased to its maximum value N. At an increment size of 0.1 dB, setting N=16 is sufficient to sweep through the adjustment range of −0.8 dB to +0.7 dB. Step 100 tests whether the calibration index is less than the maximum value N. If n is less than N, the algorithm returns to step 80 to continue testing within the adjustment range. Otherwise, each indexed power measurement from step 90 is examined at step 105 to determine the calibration index n for the minimum power value. At step 110, the determined index is recorded for setting the gain imbalance calibration. Subsequently, the gain imbalance corresponding to this determined index would be used for variable amplifier 65 during operation of I/Q modulator 60. It will be appreciated that many variations of the above-described gain calibration algorithm may be implemented. For example, if the design of I/Q modulator 60 is such that it ensures that the amplitude of the carrier is always larger in the I arm rather than the Q arm, a variable attenuator (not illustrated) could be used in place of variable amplifier 65. Further, the extent of the adjustment range, the number of sampling points within the adjustment range, and the spacing between these sampling points may all be modified depending upon the requirements of a particular I/Q modulator.

To calibrate the phase imbalance between the I and Q arms of I/Q modulator 60, the phase shift 0 introduced by phase-shifter 67 is varied through an adjustment range, for example, from −4.0 degrees to +3.5 degrees. As a result, the overall phase shift introduced by phase-shifter 678 will range from 86 degrees to 93.5 degrees. Assuming I/Q modulator 60 has been designed well, the phase imbalance should be slight so that an adjustment range extending through 90 degrees should locate the optimal phase setting. Analogous to the gain calibration algorithm, the phase may be shifted in equal increments through this adjustment range or it may be sampled more closely in the vicinity of a suspected optimal phase-shift setting.

Turning now to FIG. 6, a flowchart for a phase-shift calibration algorithm is illustrated. The algorithm starts at step 120 by inputting a tone of frequency fₘ to form the in-phase and quadrature-phase components of the modulating signal, where fₘ is within the expected operating frequency band. A calibration index variable n is used to index the phase shift as it is incremented through the adjustment range. At step 125, this index is initialized to zero. Phase-shifter 67 is configured to adjust the amount of phase shift according to this index. For example, phase-shifter 67 may provide a phase shift corresponding to the minimum value of the adjustment range when n equals 0. Each time the index increments a unit value, the phase shift is incremented a suitable value, for example 0.5 degrees. Thus at step 130, phase-shifter 67 sets its phase shift according to the current value of n. At step 135, the power of the resulting image signal is measured. As discussed with respect to FIG. 5, the frequency of the image signal depends upon whether an USB or LSB configuration has been implemented. In this case, I/Q modulator 60 is an USB configuration, so that the image signal will have a frequency equaling the difference between the carrier signal frequency and the tone frequency, (f_{c}−fₘ). At step 140, the resulting image signal power for the current calibration index n is recorded. The calibration index is incremented a unit value at step 145. In this embodiment, because every increment of n increases the phase shift of phase-shifter 67, the phase shift provided by phase-shifter 67 will eventually exceed the maximum positive value of the adjustment range as n is increased to its maximum value N. At an increment size of +0.5 degree and an adjustment range of −4.0 degrees to +3.5 degrees, the maximum value N becomes 16. Step 150 tests whether n is less than N. If n is less than N, the algorithm returns to step 130 to continue testing within the adjustment range. Otherwise, each indexed power measurement from step 135 is examined at step 155 to determine the index for the minimum power value. At step 160, the determined index is recorded for setting the phase imbalance calibration. Subsequently, phase-shifter 67 would be configured to produce a phase-shift corresponding to the determined index during operation of I/Q modulator 60.

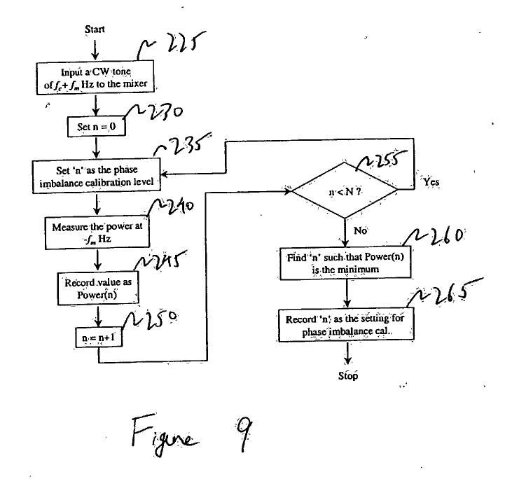

Analogous algorithms may be used to calibrate the gain and phase settings for an I/Q demodulator. Turning now to FIG. 7, an I/Q demodulator 170 is configured to perform a gain calibration using a variable amplifier 65 and a phase calibration using variable phase-shifter 67. Symbols β and φ are used to represent the gain and phase imbalance between the I and Q arms. In I/Q demodulator 170, the in-phase component of a received signal is mixed in mixer 20 with the in-phase component of the LO signal. The in-phase demodulated signal I(t) at the output of mixer 20 is low pass filtered and then converted to digital form in the analog-to-digital converter (ADC). I/Q demodulator 170 performs an analogous operation using mixer 25 to provide the quadrature-phase demodulated signal Q(t). Variable amplifier 65 adjusts the gain of the in-phase component of the LO signal having a frequency f_{c}. However, equivalent results may be obtained by adjusting the amplitude of the quadrature-phase component of the LO signal. Alternatively, the amplitudes of both the in-phase and quadrature-phase components of the LO signal may be varied with respect to one another. In addition, amplifier 65 may be located in either the I or Q signal arm subsequent to the mixing stage. For example, amplifier 65 could adjust the LPF output or the DAC output in one or both of I and Q arms. Similarly, although phase-shifter 67 is shown adjusting the phase of the LO's Q component, equivalent results may be obtained by adjusting the phase of the in-phase component of the LO. Alternatively, the phases of both the I and Q components may be varied with respect to one another.

To calibrate the gain between the I and Q arms of the I/Q demodulator 170, the gain of variable amplifier 65 is varied through an adjustment range, e.g., from −0.8 dB to +0.7 dB, where −0.8 dB is the minimum value of the adjustment range and +0.7 dB is the maximum value of the adjustment range. Assuming I/Q demodulator 170 has been designed well, the gain imbalance should be slight so that such an adjustment range extending through 0 dB should locate the optimal gain setting. As the gain is varied through this adjustment range, the power of the resulting image signal is measured so that the gain may be calibrated accordingly. While varying the gain in equal increments through the adjustment range is particularly convenient, the gain increments could be varied such that smaller increments would be used in the vicinity of the suspected optimal gain setting to more finely sample this region. Turning now to FIG. 8, a flowchart for a receiver gain imbalance calibration algorithm to locate the optimal gain setting using a constant gain increment is illustrated. In step 180, the algorithm begins by inputting a continuous wave (CW) tone at a frequency of (f_{c}+fₘ) Hz, where the frequency fₘ is chosen to be within the expected operating band for received signals and f_{c} is the LO frequency. At step 185, a calibration index variable n is set to zero. Variable amplifier 65 is configured to adjust its gain according to this calibration index. As n is incremented from 0 to a maximum value N, variable amplifier 65 will sweep through the adjustment range. For example, when n 0, variable amplifier 65 may be at the minimum value of its adjustment range, e.g., −0.8 dB. As n is incremented, the gain increases by a suitable increment such as 0.1 dB. Accordingly, at step 190, variable amplifier 65 will set its gain according to the value of the calibration index. At step 195, the power of the resulting image signal is measured. The frequency of the image signal depends upon whether the I/Q demodulator under test is in an upper sideband (USB) or lower sideband (LSB) configuration. Because I/Q demodulator 170 is an USB configuration, the image signal will have a frequency equaling fₘ. At step 200, the resulting image signal power for the current calibration index n is recorded. At step 205, n is incremented a unit value. In this embodiment, because every unit increment of n increases the gain of variable amplifier 65, the gain of variable amplifier 65 will eventually exceed the maximum positive value of the adjustment range as n is increased to its maximum value N. At an increment size of 0.1 dB, setting N to 16 is sufficient to sweep through an adjustment range of −0.8 dB to +0.7 dB. Step 210 tests whether the calibration index n is less than its maximum value N. If n is less than N, the algorithm returns to step 190 to continue sampling within the adjustment range. Otherwise, each indexed power measurement from step 200 is examined at step 215 to determine the index n for the minimum power value. At step 220, the determined index is recorded for setting the gain imbalance calibration. Subsequently, the gain of variable amplifier 65 would be set to provide the gain value corresponding to the determined index during operation of I/Q demodulator 170. It will be appreciated that many variations of the above-described gain calibration algorithm may be implemented. For example, if the design of I/Q demodulator 170 is such that it ensures that the amplitude of the local oscillator (LO) signal is always larger in the I arm rather than the Q arm, a variable attenuator (not illustrated) could be used in place of variable amplifier 65. Further, the extent of the adjustment range, the number of sampling points within the adjustment range, and the spacing between these sampling points may all be modified depending upon the requirements of a particular I/Q demodulator.

To calibrate the phase imbalance between the I and Q arms of I/Q demodulator 170, the phase shift introduced by phase-shifter 67 with respect to the variable 8 is varied through an adjustment range, for example, from −4.0 degrees to +3.5 degrees. As a result, the overall phase shift introduced by phase-shifter 67 would vary from 86 degrees to 93.5 degrees. Assuming I/Q demodulator 170 has been designed well, the phase imbalance should be slight so that an adjustment range extending through 90 degrees should locate the optimal phase setting. Analogous to the gain calibration algorithm, the phase may be shifted in equal increments through this adjustment range or it may be sampled more closely in the vicinity of a suspected optimal phase-shift setting. Turning now to FIG. 9, a flowchart for a phase-shift calibration algorithm is illustrated. The algorithm starts at step 225 by inputting a tone of frequency (f_{c}+fₘ), where f_{c} is the local oscillator signal frequency and fₘ is within the expected operating band for received signals. A calibration index n is used to index the phase shift as is incremented through the adjustment range. At step 230, this index is initialized to zero. Phase-shifter 67 is configured to adjust the amount of phase shift according to this index. For example, phase-shifter 67 may provide a phase shift corresponding to the minimum value of the adjustment range when n equals 0. Each time the calibration index increments a unit value, the phase shift is incremented a suitable value, for example 0.5 degrees. Thus at step 235, phase-shifter 67 sets its phase shift according to the current value of n. At step 240, the power of the resulting image signal is measured. As discussed previously, the frequency of the image signal depends upon whether an USB or LSB configuration has been implemented. In this case, I/Q demodulator 170 is an USB configuration, so that the image signal will have a frequency equaling fₘ. At step 245, the resulting image signal power for the current calibration index n is recorded. The calibration index is incremented at step 250. In this embodiment, because every increment of n increases the phase shift of phase-shifter 67, the phase shift provided by phase-shifter 67 will eventually exceed the maximum positive value of the adjustment range as n is increased to its maximum value N. At an increment size of +0.5 degree and an adjustment range of −4.0 degrees to +3.5 degrees, the maximum value N becomes 16. Step 255 tests whether n is less than N. If n is less than N, the algorithm returns to step 235 to continue testing within the adjustment range. Otherwise, each indexed power measurement from step 245 is examined at step 260 to determine the index for the minimum power value. At step 265, the determined index is recorded for setting the phase imbalance calibration. Subsequently, this phase imbalance setting would be used for phase-shifter 67 during operation of I/Q demodulator 170. It will be appreciated that many variations of the above-described phase calibration algorithm may be implemented. For example, if the design of I/Q demodulator 170 is such that it ensures that the phase imbalance p is always positive, a phase-delay element (not illustrated) could be used in place of variable phase-shifter 67. Further, the extent of the adjustment range, the number of sampling points within the adjustment range, and the spacing between these sampling points may all be modified depending upon the requirements of a particular I/Q demodulator.

Accordingly, although the invention has been described with respect to particular embodiments, this description is only an example of the invention's application and should not be taken as a limitation. Consequently, the scope of the invention is set forth in the following claims.

What is claimed is:

We claim:

1. A method of calibrating an I/Q modulator, wherein the I/Q modulator has a gain imbalance between its in-phase arm and its quadrature-phase arm, comprising:
providing a gain adjustment range;
adjusting the gain imbalance of the I/Q modulator through a plurality of sample points within the gain adjustment range;
modulating a signal through the adjusted I/Q modulator at each of the gain imbalance sample points;
measuring an image signal power produced by the I/Q modulator corresponding to each of the gain imbalance samples; and
determining the gain imbalance sample corresponding to the minimum image signal power to identify a gain imbalance calibration setting.

2. The method of claim 1, wherein the plurality of gain imbalance samples are evenly spaced throughout the gain adjustment range.

3. The method of claim 2, wherein the gain adjustment range extends through 0 dB.

4. The method of claim 1, further comprising:
setting the gain imbalance of the I/Q modulator according to the gain imbalance calibration setting; and modulating a signal through the set I/Q modulator.

5. The method of claim 4, wherein the I/Q modulator is configured as an USB modulator.

6. The method of claim 4, wherein the I/Q modulator is configured as an LSB modulator.

7. A method of calibrating an I/Q modulator, wherein the I/Q modulator has a phase imbalance between its in-phase arm and its quadrature-phase arm, comprising:
providing a phase adjustment range;
adjusting the phase imbalance of the I/Q modulator through a plurality of sample points within the phase adjustment range;
modulating a signal through the adjusted I/Q modulator at each of the phase imbalance sample points;
measuring an image signal power produced by the I/Q modulator corresponding to each of the phase imbalance samples; and
determining the phase imbalance sample corresponding to the minimum image signal power to identify a phase imbalance calibration setting.

8. The method of claim 7, wherein the plurality of phase imbalance samples are evenly spaced throughout the phase adjustment range.

9. The method of claim 8, wherein the phase adjustment range extends through 0 degrees.

10. The method of claim 7, further comprising:
setting the phase imbalance of the I/Q modulator according to the phase imbalance calibration setting; and
modulating a signal through the set I/Q modulator.

11. The method of claim 10, wherein the I/Q modulator is configured as an USB modulator.

12. A method of calibrating an I/Q demodulator, wherein the I/Q demodulator has a gain imbalance between its in-phase arm and its quadrature-phase arm, comprising:
providing a gain adjustment range;
adjusting the gain imbalance of the I/Q demodulator through a plurality of sample points within the gain adjustment range;
demodulating a signal through the adjusted I/Q demodulator at each of the gain imbalance sample points;
measuring an image signal power produced by the I/Q demodulator corresponding to each of the gain imbalance samples; and
determining the gain imbalance sample corresponding to the minimum image signal power to identify a gain imbalance calibration setting.

13. The method of claim 12, wherein the plurality of gain imbalance samples are evenly spaced throughout the gain adjustment range.

14. The method of claim 13, wherein the gain adjustment range extends through 0 dB.

15. The method of claim 12, further comprising:
setting the gain imbalance of the I/Q demodulator according to the gain imbalance calibration setting; and demodulating a signal through the set I/Q demodulator.

16. A method of calibrating an I/Q demodulator, wherein the I/Q demodulator has a phase imbalance between its in-phase arm and its quadrature-phase arm, comprising:
providing a phase adjustment range;
adjusting the phase imbalance of the I/Q demodulator through a plurality of sample points within the phase adjustment range;
demodulating a signal through the adjusted I/Q demodulator at each of the phase imbalance sample points;
measuring an image signal power produced by the I/Q demodulator corresponding to each of the phase imbalance samples; and
determining the phase imbalance sample corresponding to the minimum image signal power to identify a phase imbalance calibration setting.

17. The method of claim 16, wherein the plurality of phase imbalance samples are evenly spaced throughout the phase adjustment range.

18. The method of claim 17, wherein the phase adjustment range extends through 0 degrees.

19. The method of claim 18, wherein the I/Q demodulator is configured to be an USB demodulator.

20. The method of claim 18, wherein the I/Q demodulator is configured to be an LSB demodulator.
